(19) United States
(12) Patent Application Publication
(10) Pub. No.: US 2015/0144444 A1
(43) Pub. Date: May 28, 2015

(54) SHOCK ABSORBER

(71) Applicant: MANDO CORPORATION, Pyeongtaek-si (KR)

(72) Inventor: Jun Hyuk LIM, Seongnam-si (KR)

(21) Appl. No.: 14/303,740

(22) Filed: Jun. 13, 2014

(30) Foreign Application Priority Data
Nov. 27, 2013 (KR) 10-2013-0145284

(51) Int. Cl. F16F 9/512; F16F 9/19

(52) U.S. Cl. CPC F16F 9/5126; F16F 9/19
USPC 188/280

(57) ABSTRACT

A shock absorber includes: a main piston which is mounted on a piston rod reciprocating within a cylinder, slidingly reciprocates within the cylinder while contacting an inner periphery of the cylinder, and partitions the cylinder into upper and lower chambers; a communication passage which is formed in the piston rod to communicate the upper chamber with the lower chamber, and penetrates from an upper side of the main piston to a lower side of the piston rod; a housing which is mounted on a lower end of the piston rod to form an internal space, a communication hole connected to the lower chamber being formed in a bottom surface of the housing.

### CROSS-REFERENCE(S) TO RELATED APPLICATION

This application claims priority of Korean Patent Application No. 10-2013-0145284, filed on Nov. 27, 2013, in the Korean Intellectual Property Office, the contents of which are incorporated herein by reference in its entirety.

### BACKGROUND OF THE INVENTION

1. Field of the Invention

The present invention relates to a shock absorber, and more particularly, to a shock absorber which maximizes a frequency-sensitive characteristic by maximally allowing an amount of a working fluid in a frequency-sensitive section, thereby improving a ride comfort.

2. Description of the Related Art

Generally, a shock absorber is designed to support a weight of a vehicle body and suppress and dampen a vibration transferred from a road surface to the vehicle body, contributing to improving a ride comfort and protecting loaded goods and various parts of a vehicle.

Therefore, in designing a vehicle, it is very important to adjust a damping force characteristic of a shock absorber.

A frequency-sensitive damper generates a frequency characteristic by appropriately adjusting a damping force while allowing a working fluid to easily flow as much as a stroke of a free piston.

However, such a general frequency-sensitive damper has a limitation in exhibiting a frequency characteristic because a free piston is a rigid body allowing no shape deformation, or upper and lower spaces of a housing in which a free piston reciprocally moves upward and downward are closed.

### CITATION LIST

### Patent Literature

Korean Patent Application No. 10-2008-0032828
Korean Patent Application No. 10-2009-0012857

### SUMMARY OF THE INVENTION

The present invention has been made in an effort to solve the above problems and is directed to provide a shock absorber which maximizes a frequency-sensitive characteristic by maximally allowing an amount of a working fluid in a frequency-sensitive section, thereby improving a ride comfort.

According to the present invention, a shock absorber includes: a main piston which is mounted on a piston rod reciprocating within a cylinder, slidingly reciprocates within the cylinder while contacting an inner periphery of the cylinder, and partitions the cylinder into upper and lower chambers; a communication passage which is formed in the piston rod to communicate the upper chamber with the lower chamber, and penetrates from an upper side of the main piston to a lower side of the piston rod; a housing which is mounted on a lower end of the piston rod to form an internal space, a communication hole connected to the lower chamber being formed in a bottom surface of the housing; a hollow elevating piece which moves upward and downward while contacting an inner periphery of the housing and partitions the housing into upper and lower spaces; a plurality of slits which are formed in an outer periphery of the elevating piece and allow the working fluid to flow into the lower space so as to reduce a damping force when a small amount of a working fluid is introduced into the housing; and a deformation film which is mounted along an inner periphery of the elevating piece and allows an elastic deformation to extend toward a bottom side of the housing so as to close the communication hole when the elevating piece moves downward due to an increase in the amount of the working fluid introduced into the housing.

The slits may be disposed along the outer periphery of the elevating piece and be formed to have a straight-line shape from an upper edge to a lower edge of the elevating piece. The slits may be disposed along the outer periphery of the elevating piece and be formed to have an involute curve shape from an upper edge to a lower edge of the elevating piece.

A cross-sectional shape perpendicular to a forming direction of the slits may be appropriately selected from an arc shape, a notch shape, a rectangular shape, and a trapezoidal shape.

The communication passage may include: a first passage which passes through the piston rod and communicates with the upper chamber; and a second passage which is perpendicular to the first passage, communicates with the first passage, and extends to a lower end of the piston rod.

### BRIEF DESCRIPTION OF THE DRAWINGS

FIG. 1 is a cross-sectional conceptual diagram illustrating an overall configuration of a shock absorber according to an embodiment of the present invention.

FIGS. 2 and 3 are perspective views illustrating slit shapes of an outer periphery of an elevating piece, which is a main part of shock absorbers according to various embodiments of the present invention.

FIGS. 4 and 5 are cross-sectional conceptual diagrams illustrating an operation process of the shock absorber according to the embodiment of the present invention.

### DETAILED DESCRIPTION OF EXEMPLARY EMBODIMENTS

The above objects, features and advantages of the present invention will become more apparent from the following description taken in conjunction with the accompanying drawings.

However, it should be understood that the present invention is not limited to the following embodiments, and various modifications can be made without departing from the scope of the present invention.

The embodiments set forth herein are provided so that this disclosure will be thorough and complete, and will fully convey the concept of the invention to those skilled in the art.

The present invention should be defined by the appended claims.

Therefore, in some embodiments, well-known elements, well-known operations, and well-known technologies are not specifically described so as to avoid ambiguous interpretation.

In addition, like reference numerals are used to refer to like elements throughout the specification, and the terms used herein are for the purpose of describing the embodiments and are not intended to limit the present invention.

As used herein, the singular forms are intended to include the plural forms as well, unless the context clearly indicates otherwise. It will be further understood that the terms “comprises” and/or “comprising” used herein specify the presence of stated features or components, but do not preclude the presence or addition of one or more other features or components.

Unless otherwise defined, all terms (including technical and scientific terms) used herein have the same meaning as commonly understood by one of ordinary skill in the art to which example embodiments belong.

Furthermore, it will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present invention will be described with reference to the accompanying drawings.

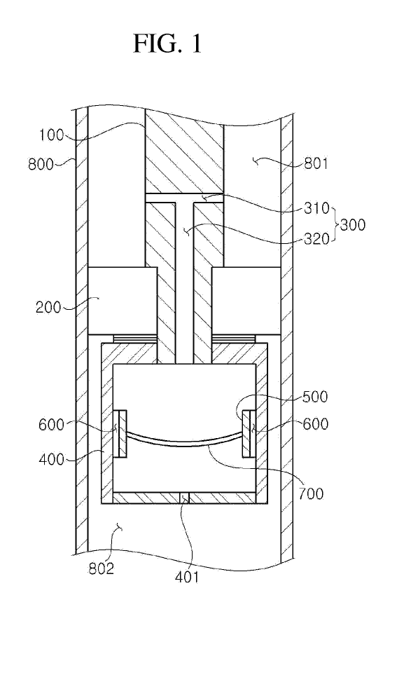

FIG. 1 is a cross-sectional conceptual diagram illustrating an overall configuration of a shock absorber according to an embodiment of the present invention.

As illustrated in FIG. 1, a main piston 200 is mounted on a piston rod 100 which reciprocates within a cylinder 800, and a communication passage 300 is formed in the piston rod 100. A housing 400 is mounted on the piston rod 100. An elevating piece 500 moves upward and downward within the housing 400. Slits 600 are formed in an outer periphery of the elevating piece 500, and a deformation film 700 is formed in the elevating piece 500.

The main piston 200 is mounted on the piston rod 100 which reciprocates within the cylinder 800. The main piston 200 slidingly reciprocates within the cylinder 800 while contacting an inner periphery of the cylinder 800, and partitions the cylinder 800 into upper and lower chambers 801 and 802. The main piston 200 generates a damping force when a working fluid is maximally introduced into the housing 400, which will be described below.

The communication passage 300 is formed in the piston rod 100 to communicate the upper chamber 801 with the lower chamber 802, and penetrates from an upper side of the main piston 200 to a lower side of the piston rod 100.

The housing 400 is mounted on a lower end of the piston rod 100 to form an internal space, and a communication hole 401 connected to the lower chamber 802 is formed in a bottom surface of the housing 400.

The elevating piece 500 is a hollow member that moves upward and downward while contacting an inner periphery of the housing 400 and partitions the housing 400 into upper and lower spaces.

A plurality of slits 600 are formed in the outer periphery of the elevating piece 500. When a small amount of a working fluid is introduced into the housing 400, the slits 600 allow the working fluid to flow into the lower space so as to reduce the damping force.

The deformation film 700 is mounted along an inner periphery of the elevating piece 500, and allows an elastic deformation to extend toward the bottom side of the housing 400 so as to close the communication hole 401 when the elevating piece 500 moves downward due to an increase in the amount of the working fluid introduced into the housing 400.

That is, the elevating piece 500 having the slits 600 formed therein and the deformation film 700 serve as a free piston. The term “free piston” used herein refers to a member which includes the elevating piece 500 having the slits 600 formed therein and the deformation film 700.

In addition to the above-described embodiment, the following various embodiments can also be applied to the present invention.

The communication passage 300 may be used as a working fluid introduction passage until the working fluid is introduced from a slight amount to a maximum amount, and may be divided into a first passage 310 and a second passage 320.

The first passage 310 passes through the piston rod 100 and communicates with the upper chamber 801. The second passage 320 is perpendicular to the first passage 310, communicates with the first passage 310, and extends to a lower end of the piston rod 100.

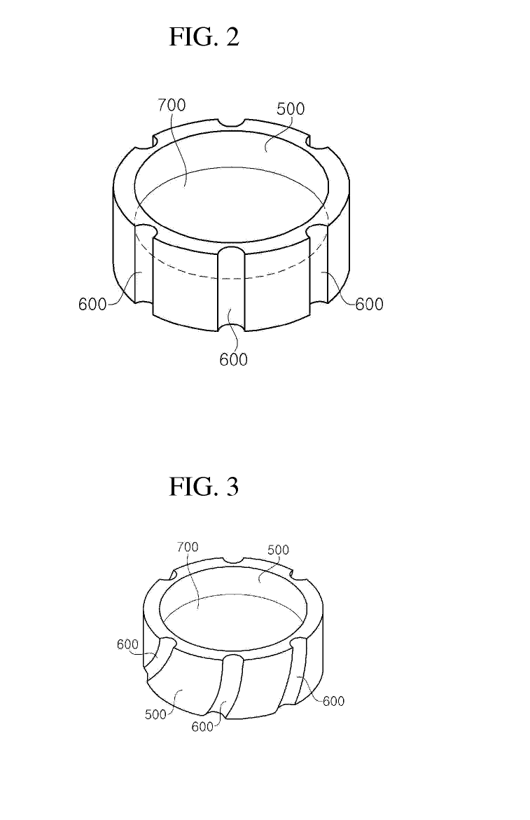

As illustrated in FIG. 2, the slits 600 may be disposed along the outer periphery of the elevating piece 500 and be formed to have a straight-line shape from an upper edge to a lower edge of the elevating piece 500.

In addition, as illustrated in FIG. 3, the slits 600 may be disposed along the outer periphery of the elevating piece 500 and be formed to have an involute curve shape from an upper edge to a lower edge of the elevating piece 500, that is, in an oblique direction.

The slits 600 serve as an orifice. In particular, as illustrated in FIG. 3, when the slits 600 are formed to have an involute curve shape, a passing distance of the working fluid is increased and a resistance is also increased. Therefore, the free piston can be more easily operated.

Herein, the cross-sectional shape perpendicular to the forming direction of the slits 600 is illustrated as an arc shape, but is not necessarily limited thereto. It is apparent that the cross-sectional shape may be applied and modified in various shapes, such as a notch shape, a rectangular shape, or a trapezoidal shape.

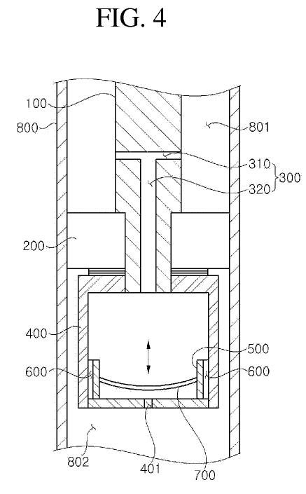

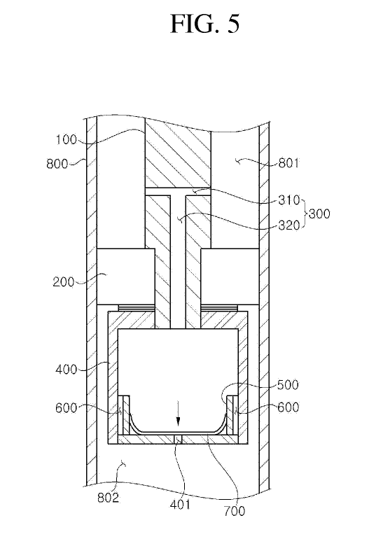

Hereinafter, the operation process of the shock absorber of FIGS. 4 and 5 according to the embodiment of the present invention will be described with reference to FIGS. 1 to 3.

First, when a slight amount of the working fluid is introduced to the housing 400 through the first passage 310 and the second passage 320 in a high-frequency section, the elevating piece 500 hardly reciprocates as illustrated in FIG. 1 and causes the working fluid to flow down through the slits 600 to thereby reduce a damping force.

Then, when the working fluid is more introduced to the housing 400 through the communication passage 300 in the mid-frequency section, the elevating piece 500 reciprocates and then closes the slits 600 when contacting the bottom surface of the housing 400, as illustrated in FIG. 4. At this time, a stronger damping force is generated.

Then, in a low-frequency section, the working fluid is maximally introduced to the housing 400 through the communication passage 300, and the working fluid remaining in the lower space of the deformation film 700 of the elevating piece 500, that is, the lower space of the housing 400, is all discharged through the communication hole 401.

This is because the deformation film 700 is elastically deformed by a pressure difference between the upper and lower spaces of the housing 400 and pushes the working fluid through the communication hole 401, as illustrated in FIG. 5. From this point of time, only the main piston 200 is operated to achieve a high damping force.

Therefore, according to the present invention, as described above, a variation rate of the damping force from the high-frequency section to the low-frequency section is increased to maximize a frequency-sensitive characteristic, thereby providing an excellent ride comfort to passengers.

The basic technical idea of the present invention is to provide the shock absorber which maximizes a frequency-sensitive characteristic by maximally allowing the amount of the working fluid in the frequency-sensitive section, thereby improving the ride comfort.

The above-described configurations according to the present invention can achieve the following effects.

That is, the plurality of slits are formed in the outer periphery of the elevating piece, which reciprocally moves upward and downward within the housing while interlocking with the reciprocal upward/downward movement of the piston rod, and the deformation film allowing the shape deformation is provided in the inner periphery of the elevating piece. Therefore, the variation rate of the damping force from the section in which a slight amount of the working fluid is introduced to the section in which a maximum amount of the working fluid is introduced, that is, from the high-frequency section to the low-frequency section, is increased to maximize a frequency-sensitive characteristic, thereby providing an excellent ride comfort to passengers.

While the embodiments of the present invention have been described with reference to the specific embodiments, it will be apparent to those skilled in the art that various changes and modifications may be made without departing from the spirit and scope of the invention as defined in the following claims.

DESCRIPTION OF REFERENCE NUMERALS

| | |
|---|---|
| 100: piston rod | 200: main piston |
| 300: communication passage | 310: first passage |
| 320: second passage | 400: housing |
| 401: communication hole | 500: elevating piece |
| 600: slit | 700: deformation film |

What is claimed is:

1. A shock absorber comprising:
a main piston which is mounted on a piston rod reciprocating within a cylinder, slidingly reciprocates within the cylinder while contacting an inner periphery of the cylinder, and partitions the cylinder into upper and lower chambers;
a communication passage which is formed in the piston rod to communicate the upper chamber with the lower chamber, and penetrates from an upper side of the main piston to a lower side of the piston rod;
a housing which is mounted on a lower end of the piston rod to form an internal space, a communication hole connected to the lower chamber being formed in a bottom surface of the housing;
a hollow elevating piece which moves upward and downward while contacting an inner periphery of the housing and partitions the housing into upper and lower spaces;
a plurality of slits which are formed in an outer periphery of the elevating piece and allow the working fluid to flow into the lower space so as to reduce a damping force when a small amount of a working fluid is introduced into the housing; and
a deformation film which is mounted along an inner periphery of the elevating piece and allows an elastic deformation to extend toward a bottom side of the housing so as to close the communication hole when the elevating piece moves downward due to an increase in the amount of the working fluid introduced into the housing.

2. The shock absorber according to claim 1, wherein the slits are disposed along the outer periphery of the elevating piece and are formed to have a straight-line shape from an upper edge to a lower edge of the elevating piece.

3. The shock absorber according to claim 1, wherein the slits are disposed along the outer periphery of the elevating piece and are formed to have an involute curve shape from an upper edge to a lower edge of the elevating piece.

4. The shock absorber according to claim 1, wherein a cross-sectional shape perpendicular to a forming direction of the slits is an arc shape.

5. The shock absorber according to claim 1, wherein a cross-sectional shape perpendicular to a forming direction of the slits is a notch shape.

6. The shock absorber according to claim 1, wherein a cross-sectional shape perpendicular to a forming direction of the slits is a rectangular shape.

7. The shock absorber according to claim 1, wherein a cross-sectional shape perpendicular to a forming direction of the slits is a trapezoidal shape.

8. The shock absorber according to claim 1, wherein the communication passage comprises:
a first passage which passes through the piston rod and communicates with the upper chamber; and
a second passage which is perpendicular to the first passage, communicates with the first passage, and extends to a lower end of the piston rod.
